(19) United States
(12) Patent Application Publication
(10) Pub. No.: US 2016/0321825 A1
(43) Pub. Date: Nov. 3, 2016

(54) MEASURING APPARATUS, SYSTEM, AND PROGRAM

(71) Applicant: 3M INNOVATIVE PROPERTIES COMPANY, St. Paul, MN (US)

(72) Inventors: Fumio Karasawa, Tokyo (JP); Guruprasad Somasundaram, Minneapolis, MN (US); Robert W. Shannon, Roseville, MN (US); Richard J. Moore, Maplewood, MN (US); Anthony J. Sabelli, Darien, CT (US); Ravishankar Sivalingam, Foster City, CA (US)

(21) Appl. No.: 15/106,219

(22) PCT Filed: Dec. 23, 2014
(86) PCT No.: PCT/US14/72034

§ 371 Date: Jun. 17, 2016

(30) Foreign Application Priority Data
Dec. 27, 2013 (JP) 2013-273189

(51) Int. Cl. G06T 7/40; G06K 9/62; H04N 5/232; G06K 9/46

(52) U.S. Cl. CPC G06T 7/408; G06K 9/4671; G06K 9/6267; H04N 5/232; G06T 2207/10024

(57) ABSTRACT

To provide an apparatus, a system, and a program that can easily detect an image region where retroreflected light is recorded without being influenced by a neighboring object. In one embodiment, a measuring apparatus (1) includes an imaging unit (11), a converter (141) that converts first image data captured by the imaging unit using light emission for photography and second image data captured by the imaging unit without using the light emission for photography to luminance values, a differential processor (142) that calculates a difference between a first luminance value based on the first image data and a second luminance value based on the second image data for each pixel and generates an output image visually representing a region where the difference is present based on an obtained differential image, and a display unit (16) that displays the output image.

This application claims the benefit of Japan Application No. 2013-273189, filed Dec. 27, 2013, the entire content of which being incorporated herein by reference.

### TECHNICAL FIELD

The present disclosure relates to a measuring apparatus, a system, and a program.

### BACKGROUND

FIG. 8 is a diagram illustrating a retroreflecting material. Retroreflection is a reflection phenomenon that causes incident light to return in the incident direction regardless of the angle of incidence. A retroreflecting material 80 includes a coating 82 of a transparent synthetic resin containing many fine particles 81. Incident light 83, which is incident to the retroreflecting material, is deflected in the particles 81, is focused at one point, and then is reflected to become reflected light 84 traveling back in the original direction, passing through the particles again. Accordingly, the retroreflecting material appears to shine when seen from the direction of light incidence, but does not appear to shine when seen from a direction different from the direction of light incidence. In addition, the retroreflecting material 80 may be achieved by another configuration such as a three-dimensionally formed prism.

Patent Document 1 describes an image recognition apparatus that identifies, from a captured image, a target for recognition formed by a retroreflecting material. This apparatus identifies that a captured image is equivalent to a target for recognition based on the image capture result obtained when light is illuminated from a first illumination unit and the image capture result obtained when light is illuminated from a second illumination unit located separated from the first illumination unit by a predetermined distance.

Patent Document 2 describes an electronic still camera that, in response to one instruction to capture an image, consecutively performs shooting using a flashlight unit and shooting without using the flashlight unit to suppress noise in a captured image with a night scene as the background, thereby obtaining a high-quality image.

### REFERENCE DOCUMENTS

### Patent Documents

PATENT DOCUMENT 1: Japanese Unexamined Patent Application Publication No. JP2003-132335A

PATENT DOCUMENT 2: Japanese Unexamined Patent Application Publication No. JP2005-086488A

### SUMMARY

When the intensity of light reflected by retroreflection is sufficiently high, an image region where the reflected light is recorded and the background can easily be discriminated. However, when an object with, for example, a degraded retroreflecting film adhered thereto is shot, the difference in luminance between a retroreflecting region on an image and a region without retroreflection is not likely to be so large. In this case, when a bright object like a white object is captured in an image, the luminance value of the image region for that object increases, making it difficult to detect an image region of retroreflected light. A luminance value refers to a weighted sum of all channels of image data. For example, for image data with R, G, B values in the three color channels in RGB format, a luminance value refers to W₁*R+W₂*G+W₃*B where W₁, W₂, and W₃ are weighting factors for the R, G, B channels respectively. As another example, an equivalent scalar value for each pixel resulting in a single channel image can also be obtained by performing a directed weighted combination (DWC) of two images (without explicit differencing) w1*Rf_f+w2*G_f+w3*B_f+w4*R_nf+w5*G_nf+w6*B_nf where w1,w2,w3 are the weights corresponding to R_f, G_f, and B_f which are the red, green and blue channels for the image captured with light emission for photography and R_nf, G_nf, and B_nf are the red, green and blue channels of the image captured without light emission photography and w4, w5 and w6 are the corresponding weights.

Accordingly, an object of the present disclosure is to provide an apparatus, a system, and a program that can easily detect an image region where retroreflected light is recorded without being influenced by a neighboring object.

### Means to Solve the Problem

An apparatus according to the present disclosure includes an imaging unit, a converter that converts first image data captured by the imaging unit using light emission for photography and second image data captured by the imaging unit without using the light emission for photography to luminance values, a differential processor that calculates a difference between a first luminance value based on the first image data and a second luminance value based on the second image data for each pixel to generate an output image visually representing a region where the difference is present based on an obtained differential image, and a display unit that displays the output image. Alternatively, the luminance values can be directly generated by DWC as described above by the differential processor in which the differencing operation is implicit.

As for the apparatus, it is preferable that the differential processor detects a region of light reflected by a retroreflecting material in the first image data or the second image data based on an area or shape of a region of the differential image. Other features of the differential image can also be used to detect the retroreflecting region, for example, number of pixels included in the contour of the retroreflecting region, aspect ratio (width/height of bounding rectangle of the region), area of minimum bounding rectangle, extent (ratio of contour area to minimum bounding rectangle area), feret ratio (maximum feret diameter/breadth of contour), circularity (4π*contour area/contour perimeter2), convex hull (contour points of enclosing convex hull), convex hull area, solidity (ratio of contour area to its convex hull area), the diameter of the circle whose area is equal to the contour area, the median stroke width of the stroke width transform, and the variance of stroke width values produced using the stroke width transform (e.g., as described in “Detecting text in natural scenes with stroke width transform,” by Epshtein, Boris, Eyal Ofek, and Yonatan Wexler, Computer Vision and Pattern Recognition (CVPR), 2010 IEEE Conference, pages 2963-2970), or the like.

It is preferable that the apparatus further includes a calculating unit that calculates a feature indicator of a region of the differential image where light reflected by the retroreflecting material is observed.

It is preferable that in the apparatus, the display unit displays the feature indicator calculated by the calculating unit along with the output image.

It is preferable that the apparatus further includes a determination unit that determines whether or not the feature indicator calculated by the calculating unit lies within a reference range, wherein the display unit displays a result of determination made by the determination unit along with the output image.

It is preferable that in the apparatus, the converter converts each of the first image data and the second image data to data including a relative luminance value, and the differential processor calculates a difference between a first relative luminance value based on the first image data and a second relative luminance value based on the second image data for each pixel, and generates the differential image. Alternatively, a single luminance value can also be obtained by DWC as described above. In some other embodiments, the differential processor may use luminance value based on the image data captured using light emission for photography.

It is preferable that in the apparatus, the converter converts each of the first image data and the second image data to data including a relative luminance value, acquires, for each of the first image data and the second image data, a reference luminance value of a subject using image information from the imaging unit, and, using the reference luminance value, converts the relative luminance value for each pixel to an absolute luminance value; and the differential processor calculates a difference between a first absolute luminance value based on the first image data and a second absolute luminance value based on the second image data for each pixel and generates the differential image.

It is preferable that the apparatus further includes a light emitting unit disposed adjacent to a lens forming the imaging unit.

A system according to the present disclosure includes a terminal device and a server that can communicate with each other. The terminal device includes an imaging unit, a terminal communication unit that transmits first image data captured by the imaging unit using light emission for photography and second image data captured by the imaging unit without using the light emission for photography to the server, and receives an output image produced based on the first image data and the second image data from the server, and a display unit that displays the output image. The server includes a converter that converts the first image data and the second image data to luminance values, a differential processor that calculates a difference between a first luminance value based on the first image data and a second luminance value based on the second image data for each pixel and generates an output image visually representing a region where the difference is present based on an obtained differential image, and a server communication unit that receives the first image data and the second image data from the terminal device, and transmits the output image to the terminal device.

A program according to the present disclosure permits a computer to acquire first image data imaged by the imaging unit using light emission for photography and second image data imaged by the imaging unit without using the light emission for photography, convert the first image data and the second image data to luminance values, calculate a difference between a first luminance value based on the first image data and a second luminance value based on the second image data for each pixel to generate a differential image or obtain a combined luminance value using DWC, and display an output image visually representing a region where the difference is present based on the differential image.

The apparatus, the system, and the program according to the present disclosure can easily detect an image region where retroreflected light is recorded without being influenced by a neighboring object.

### BRIEF DESCRIPTION OF DRAWINGS

The accompanying drawings are incorporated in and constitute a part of this specification and, together with the description, explain the advantages and principles of the invention. In the drawings,

FIG. 1 is a schematic configuration diagram of a terminal device 1;

FIGS. 2A to 2E are diagrams illustrating a process of detecting an image region where light reflected by a retroreflecting material is recorded;

FIG. 3 is a functional block diagram of a control unit 14;

FIG. 4 is a relational diagram of data to be used by a converter 141;

FIG. 5 is a diagram illustrating an example of a method of extracting a target region on an image;

FIG. 6 is a flowchart illustrating an example of the process of detecting an image region where light reflected by a retroreflecting material is recorded;

FIG. 7 is a schematic configuration diagram of a communication system 2;

FIG. 8 is a diagram illustrating a retroreflecting material;

FIG. 9 shows some examples of receiver operator characteristics (ROC) curves;

FIG. 10 illustrates a flowchart of one embodiment of a process of detecting an image region where light reflected by a retroreflecting material is recorded using luminance value based on image captured using light emission photography;

FIG. 11A shows a sample luminance image obtained by converting an RGB format image to a grayscale image using luminance values;

FIG. 11B shows a binarized image of the grayscale image illustrated in FIG. 11A;

FIG. 11C shows the result of a clean-up image obtained using a pattern recognition algorithm on the binarized image illustrated in FIG. 11B; and

FIG. 12 shows an example of a decision tree trained to detect circular regions of interest that are retroreflective.

### DETAILED DESCRIPTION OF ILLUSTRATIVE EMBODIMENTS

The following describes an apparatus, a system, and a program according to the present disclosure in detail with reference to the attached figures. Note that the technical scope of the present disclosure is not limited to the embodiments of the apparatus, system, and program, and includes matters recited in the appended claims, and equivalents thereof.

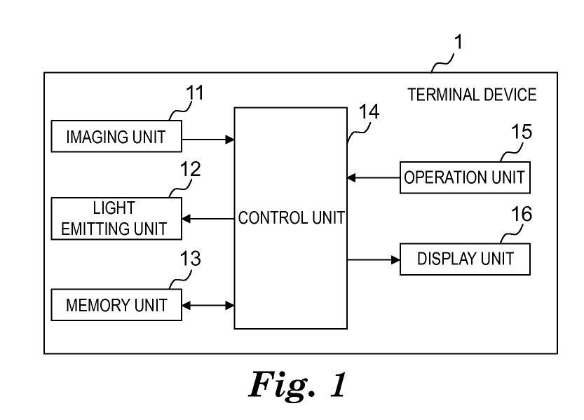

FIG. 1 is a schematic configuration diagram of a terminal device 1. The terminal device 1 includes an imaging unit 11, a light emitting unit 12, a storage unit 13, a control unit 14, an operation unit 15, and a display unit 16. The terminal device 1 detects an image region in a digital image where light reflected by a retroreflecting material is recorded, calculates, for example, the luminance value and area of that region, and outputs the luminance value and area along with an output image representing the region. The terminal device 1 is a mobile terminal such as a smart phone with a built-in camera.

The imaging unit 11 shoots the image of a target to be measured to acquire image data of the object for measurement in the form of RAW (DNG) data, JPEG (JFIF) data, sRGB data, or the like. Any of the data forms is available, but the following mainly describes an example where the imaging unit 11 acquires JPEG (JFIF) data.

The light emitting unit 12 emits light when the imaging unit 11 shoots an image as needed. It is preferable that the light emitting unit 12 is disposed adjacent to the lens of the imaging unit 11. This arrangement makes the direction in which light emission for photography (flash or torch) is incident to a retroreflecting material and reflected thereat substantially identical to the direction in which the imaging unit 11 shoots an image, so that much of light reflected by the retroreflecting material can be imaged. The light emitting unit 12 can emit various types of visible or invisible lights, for example, visible light, fluorescent light, ultraviolet light, infrared light, or the like.

The storage unit 13 is, for example, a semiconductor memory to store data acquired by the imaging unit 11, and data necessary for the operation of the terminal device 1. The control unit 14 includes a CPU, a RAM, and a ROM, and controls the operation of the terminal device 1. The operation unit 15 includes, for example, a touch panel and key buttons to be operated by a user.

The display unit 16 is, for example, a liquid crystal display, which may be integrated with the operation unit 15 as a touch panel display. The display unit 16 displays an output image obtained by the control unit 14.

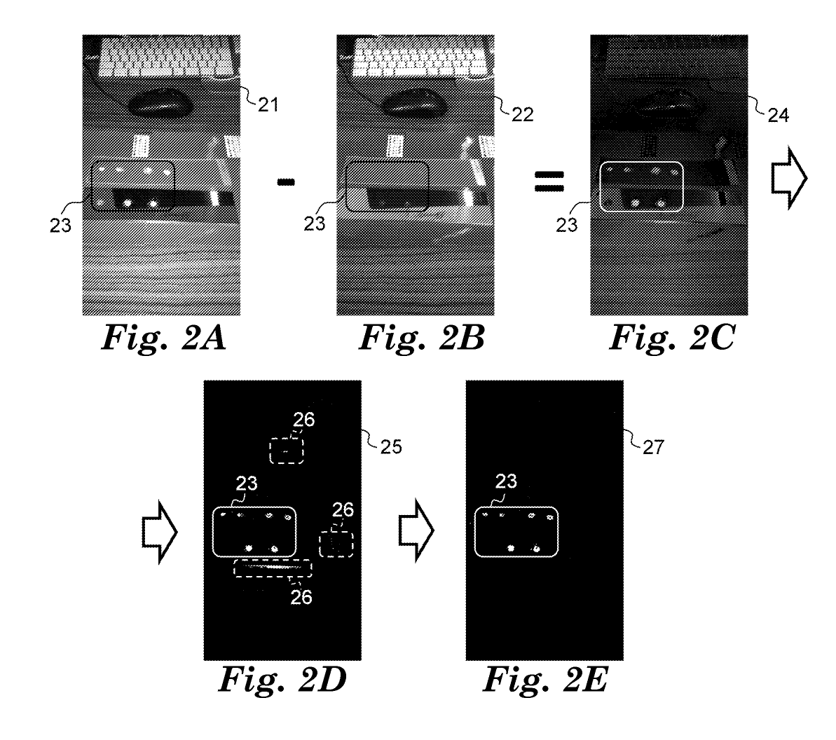

FIGS. 2A to 2E are diagrams illustrating a process of detecting an image region where light reflected by a retroreflecting material is recorded. FIG. 2A illustrates an example of a first image 21 shot by the imaging unit 11 using light emission for photography from the light emitting unit 12. FIG. 2B illustrates an example of a second image 22 shot by the imaging unit 11 without using light emission for photography from the light emitting unit 12. In this example, in a region 23 encircled by a solid line, there are seven spots having a retroreflecting material applied. While those spots are hardly seen in the second image 22 shot without the light emission for photography, the light emission for photography is reflected by the retroreflecting material toward the imaging unit 11 in the first image 21 using the light emission for photography, so that the seven spots can be clearly identified. In this manner, the terminal device 1 first acquires image data (first image data) of the first image 21 shot using the light emission for photography and image data (second image data) of the second image 22 shot without using the light emission for photography.

FIG. 2C illustrates a differential image 24 generated based on the differential value based on the calculated luminance value of each pixel in the first image 21 (first luminance value) and the calculated luminance value of each pixel in the second image 22 (second luminance value). The first luminance value and the second luminance value may be absolute luminance values or relative luminance values. The differential value can be, for example, an absolute difference that is the difference between the first absolute luminance value and the second absolute luminance value, a signed difference that is the difference between the first relative luminance value and the second relative luminance value, a weighted difference that is the difference between the first luminance value times a first factor and the second luminance value times a second factor. As another example, the differential value can be a combined luminance value calculated using DWC. In the differential image 24, spots mainly in the region 23 applied with the retroreflecting material appear bright. In this way, the terminal device 1 generates luminance images from the first image data and the second image data, respectively and generates a differential image between the two luminance images.

To generate a differential image from two images, those images need to be aligned accurately. Therefore, the imaging unit 11 captures the image using the light emission for photography and the image not using the light emission for photography substantially at the same time, using what is called exposure bracketing. With the terminal device 1 fixed on, for example, a tripod or a fixed table by a user, the first image 21 and the second image 22 aligned with each other may be shot without using exposure bracketing. Because, when a surface with a metallic luster is shot, illumination light reflected at the surface may be shown in the image, the imaging unit 11 may shoot the first image 21 and the second image 22 from a direction oblique to the surface that has the retroreflecting material applied.

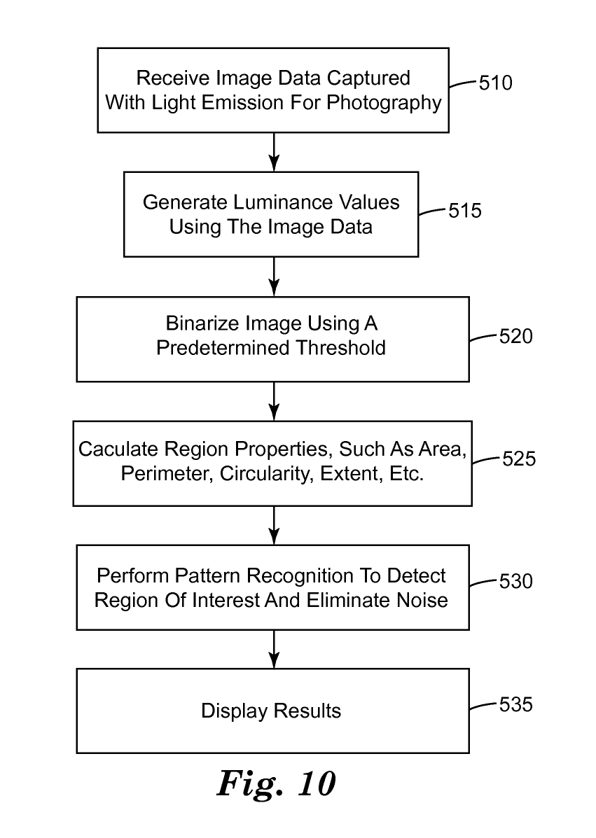

FIG. 2D illustrates a binarized image 25 obtained by setting a proper threshold for luminance values and performing binarization on the differential image 24. In some embodiments, the proper threshold can be chosen based on the desired operating point on a receiver operator characteristics (ROC) curve. The ROC curve is a plot of false positive rate (percentage pixels that are background detected as our region of interest) and true positive rate (percentage pixels in the true region of interest detected as region of interest). FIG. 9 shows some examples of ROC curves, such as ROC curves for different differencing operations such as absolute difference, signed difference, and using only image captured using light emission for photography (labeled “Flash” in the FIG. 9). Using these curves a threshold according to, for example, 0.01 false positive rate (or 1% false positive rate), may be chosen. In one example of using signed difference to select proper threshold, this yields approximately a 30% true positive rate (in pixel counts). In some cases, the three locations, which are coated with the retroreflecting material in the region 23 can be identified clearly in the binarized image 25.

The terminal device 1 performs binarization on the differential image, and further cancels noise based on, for example, the area or shape of the region where there is a difference between luminance values, or the level of the differential image difference (luminance difference), thereby extracting an image region where reflected light originating from retroreflection is recorded. Noise can also be eliminated using a pattern recognition algorithm such as a Decision Tree classifier operating on one or more of the following region properties: area and perimeter of the contour, number of pixels included in the contour, aspect ratio (width/height of bounding rectangle), area of minimum bounding rectangle, extent (ratio of contour area to minimum bounding rectangle area), feret ratio (maximum feret diameter/breadth of contour), circularity (4π*contour area/contour perimeter²), convex hull (contour points of enclosing convex hull), convex hull area, solidity (ratio of contour area to its convex hull area), the diameter of the circle whose area is equal to the contour area, the median stroke width of the stroke width transform, and the variance of stroke width values produced using the stroke width transform. Alternatively, other classification algorithms, for example, such as K-nearest neighbor, support vector machines, discriminant classifiers (linear, quadratic, higher order), random forests, or the like, can be used.

FIG. 2E is an example of a final output image 27 obtained by canceling the noise 26 contained in the binarized image 25. The terminal device 1 generates the output image processed based on the differential image in such a way that the image region where reflected light originating from retroreflection is recorded is easily identified, and displays the output image on the display unit 16. Then, the terminal device 1 calculates, for example, the luminance value and area of the image region detected in the aforementioned manner, and displays the luminance value and area along with the output image.

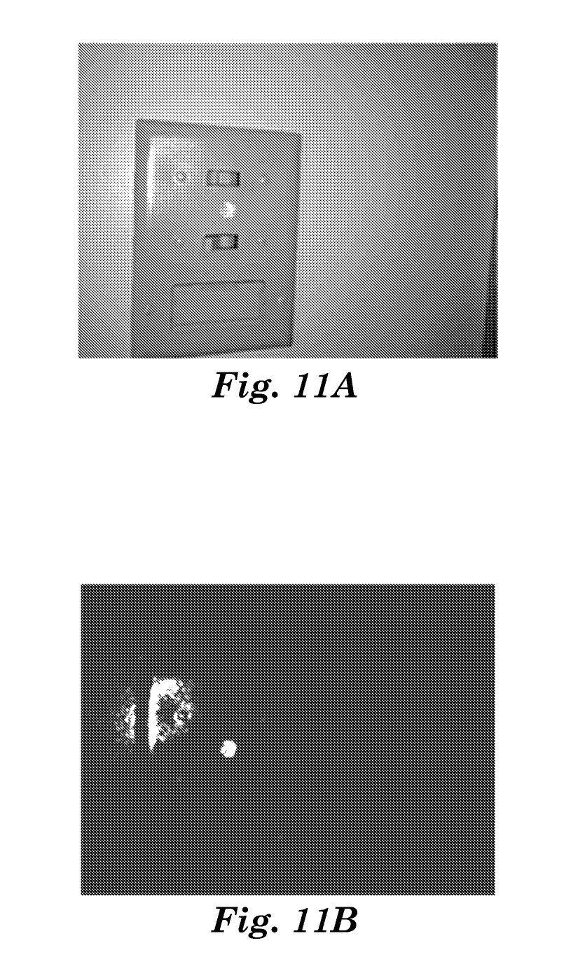

FIG. 10 illustrates a flowchart of one embodiment of a process of detecting an image region where light reflected by a retroreflecting material is recorded using luminance value based on image captured using light emission photography only. First, the apparatus, for example, the terminal device 1 or a system, receives image data captured with light emission for photography (step 510). Next, the apparatus generates luminance values using the image data (step 515). The apparatus may binarize image using a predetermined threshold (step 520). The apparatus may calculate region properties, such as area, perimeter, circularity, extent, or the like (step 525). Optionally, the apparatus may perform pattern recognition to detect region of interest and eliminate noise (step 530). In another optional step, the apparatus may display results (step 535).

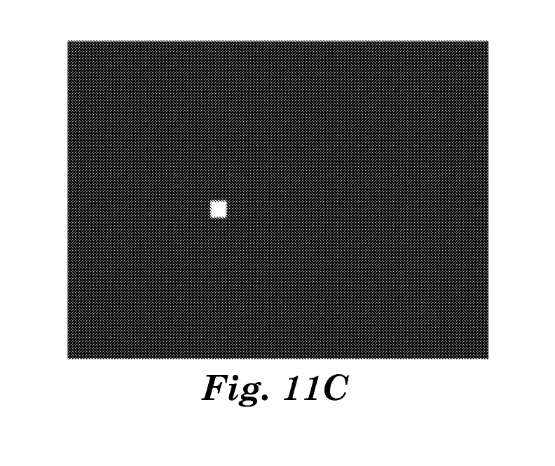

FIG. 11A shows a sample luminance image obtained by converting an RGB format image to a grayscale image using luminance values, for example, using grayscale luminance value=0.2126*R+0.7152*G+0.0722*B. FIG. 11B shows the binarized image after performing thresholding operation on the grayscale image illustrated in FIG. 11A. The threshold used, as an example, can be 0.9 in a double representation. This threshold was chosen as described before based on a desired operating point on the ROC curve corresponding to the “Flash” in FIG. 9. FIG. 11C shows the result of a clean-up image obtained using a pattern recognition algorithm (e.g., decision tree, etc.) operating on the region properties described herein. This clean-up image indicates only the region of interest and reduces noise.

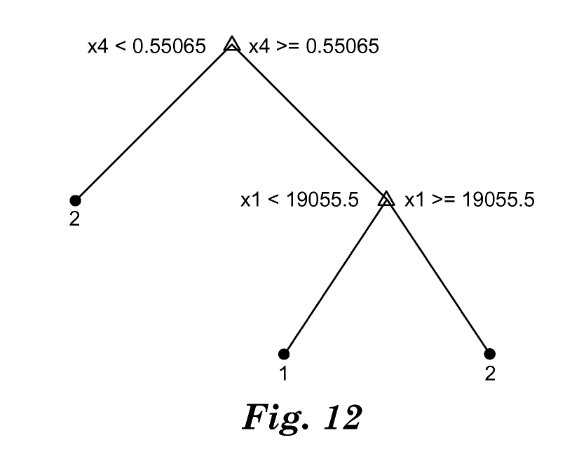

FIG. 12 shows an example of a decision tree trained to detect circular regions of interest that are retroreflective. In FIG. 12, x4 corresponds to the region property “extent” and x1 corresponds to the region property “area”. The output label 1 in the leaf nodes of the decision tree corresponds a region of interest prediction and a label 2 corresponds to noise. Using the pattern recognition, noise can be reduced.

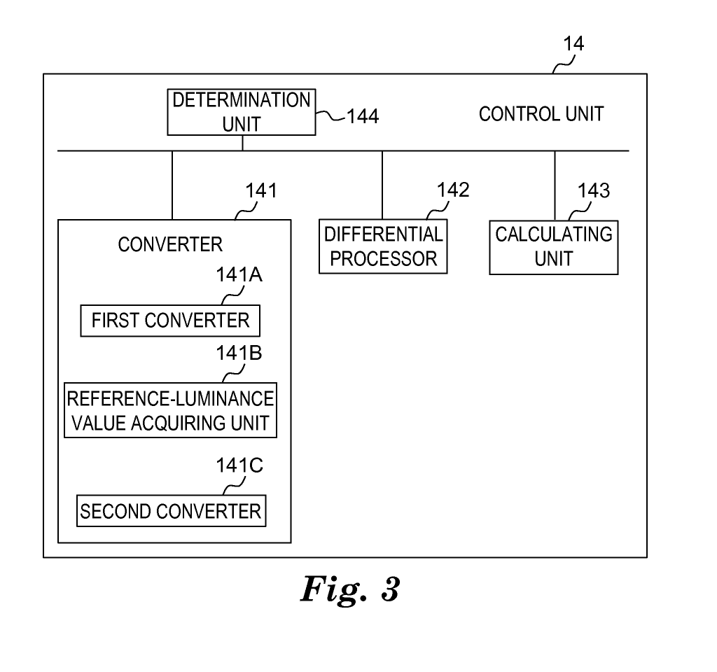

FIG. 3 is a functional block diagram of the control unit 14. The control unit 14 includes a converter 141, a differential processor 142, a calculating unit 143, and a determination unit 144 as functional blocks.

Converter 141 includes a first converter 141A, a reference luminance value acquiring unit 141B, and a second converter 141C. The converter 141 converts the first image data acquired by the imaging unit 11 using the light emission for photography and the second image data acquired by the imaging unit 11 without using the light emission for photography to linear scale luminance values to generate two luminance images.

Accordingly, the converter 141 obtains a relative luminance value for each of first image data and second image data, obtains a reference luminance value of a subject of each image using shooting information from the imaging unit 11, and converts the relative luminance value for each pixel to an absolute luminance value using the reference luminance value. The absolute luminance value is a quantity expressed by a unit such as nit, cd/m2, ftL or the like. At this time, the converter 141 extracts image data shooting information, such as, the value of the effective aperture (F number), shutter speed, ISO sensitivity, focal distance and shooting distance from, for example, Exif data accompanying the image data acquired by the imaging unit 11. Then, the converter 141 converts the first image data and the second image data to data including the absolute luminance value using the extracted shooting information.

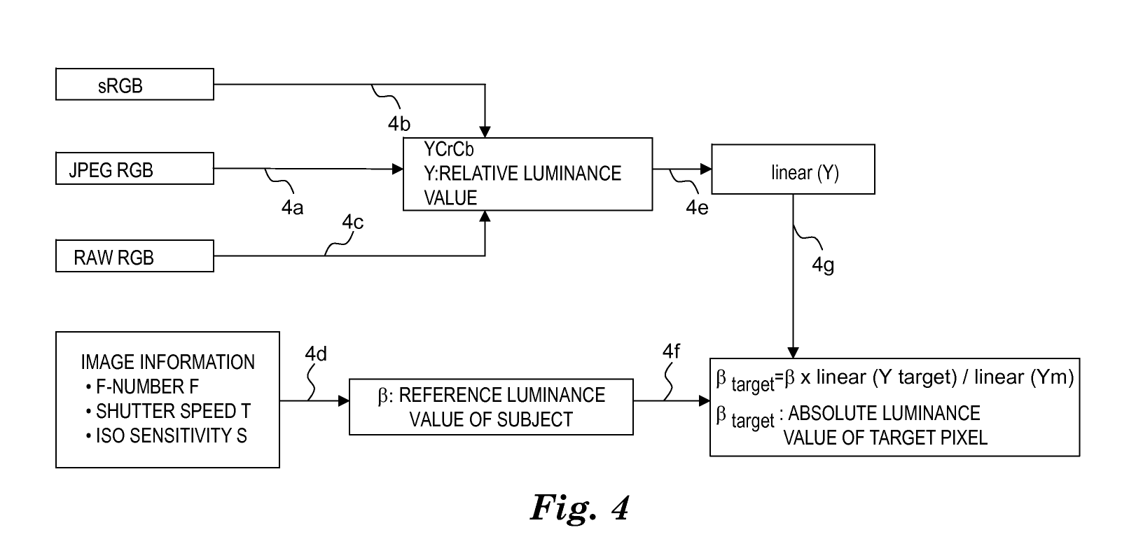

FIG. 4 is a relational diagram of data used by the converter 141. The first converter 141A converts JPEG data of an image acquired by the imaging unit 11 to YCrCb data including the relative luminance value (arrow 4a). The value of a luminance signal Y is the relative luminance value. At this time, the first converter 141A may convert JPEG data to YCrCb data according to a conversion table that is specified by the known IEC 619662-1 standards. When image data is sRGB data, the first converter 141A may also convert the sRGB data according to a conversion table that is specified by the known standards (arrow 4b). With regard to RAW data, the first converter 141A may convert the RAW data according to a conversion table that is provided by the manufacturer of the imaging unit 11 (arrow 4c).

The reference-luminance value acquiring unit 141B acquires a reference luminance value β of a subject included in the image acquired by the imaging unit 11 using image data shooting information. Provided that the value of the effective aperture (F number), the shutter speed (sec), and the ISO sensitivity of the imaging unit 11 are F, T, and S, respectively, and the average reflectance of the entire screen is assumed to be 18%, the reference luminance value β (cd/m2 or nit) of the subject is expressed by the following equation:

β=10×F²/(k×S×T) (1)

where k is a constant for which a value such as 0.65 is used. The reference luminance value acquiring unit 141B uses this equation to calculate the reference luminance value β from the values of the effective aperture (F number), the shutter speed T (sec), and the ISO sensitivity S (arrow 4d).

The shooting information of F, S, and T are generally recorded in Exif data accompanying RAW data, JPEG data or the like. Accordingly, the reference-luminance value acquiring unit 141B extracts F, S, and T from the Exif data to calculate the reference luminance value β. This way eliminates the need for the user to manually input shooting information, thus improving the convenience for the user. It is noted that when Exif data is not available, the user inputs the values of F, S, and T via the operation unit 15, and the reference luminance value acquiring unit 141B acquires the input values.

The second converter 141C converts a relative luminance value Y to an absolute luminance value using the reference luminance value β. At this time, the second converter 141C first converts the relative luminance value Y to a linear scale to obtain a linear relative luminance value linearY (arrow 4e). Then, the second converter 141C converts a linear relative luminance value linearY_{target} of each pixel of an object for measurement to an absolute luminance value βtarget using the reference luminance value b calculated by the reference luminance value acquiring unit 141B (arrows 4f, 4g).

In general, the RGB value of each pixel displayed on the display is converted to a non-linear scale by gamma correction to compensate for the non-linearity of the display. To use non-linear RGB values, therefore, the second converter 141C converts the luminance signal Y (non-linear value) of each pixel calculated by the first converter 141A to linear scale linearY with the following equation using, for example, a typical gamma correction value of 2.2:

linearY=Y^{2.2} (2)

Performing such gamma correction has an advantage in that multiple points and multiple values are easily processed at a high speed. Of course, the second converter 141C can convert the relative luminance value Y to a linear scale by a method specific to each color space regardless of the equation (2).

When the reference luminance value β for the reflectance of 18% is obtained, the second converter 141C calculates an absolute luminance value βtarget of the target pixel using the following equation based on the linear relative luminance value linearY_{target} of the target pixel:

β_{target}=β×linearY_{target}/linearYₘ (3)

where linearYₘ is a linear relative luminance value (reference level) when the average reflectance of the entire screen is assumed to be 18%. For an 8-bit system of 0 to 255, the reference level becomes 46 (maximum value of 255×0.18) from the 2.2 gamma standards of the display and the definition of the 18% average reflectance, so that

linearYₘ=46/255.

When shooting information of Exif data is available or its equivalent information is input by the user manually, the absolute luminance values βtarget for the pixels at the individual coordinates on an image can be obtained from any one of sRGB or RGB of JPEG data, or RGB of RAW data through the aforementioned procedures. The absolute luminance values can improve the accuracy in comparing images acquired under differing illumination conditions to each other. For example, it is possible to compare an image shot with normal light with an image shot by fill light such as flashlight to determine whether the intensity of the fill light is sufficient or not.

The second converter 141C may perform correction associated with reduction in the quantity of neighboring light (Vignetting) on the final absolute luminance value βtarget with a known method, such as the method called cosine fourth power, using information on the angle of view obtained from the focal distance of the shooting lens of the imaging unit 11 and the size of the image capturing elements. This approach can improve the accuracy of the absolute luminance values.

The converter 141 may generate luminance images of first image data and second image data from the relative luminance values thereof without calculating the absolute luminance values. In this case, the converter 141 should include only the first converter 141A. The relative luminance value can be more easily calculated than the absolute luminance value, so the relative luminance value suffices when accuracy is not needed.

The differential processor 142 calculates, for each pixel, a differential value between a first luminance value based on the first image data converted by the converter 141 and a second luminance value based on the second image data converted by the converter 141 to generate a differential image as illustrated in FIG. 2C. The first luminance value and the second luminance value may be absolute luminance values or relative luminance values. The differential value can be, for example, an absolute difference that is the difference between the first absolute luminance value and the second absolute luminance value, a signed difference that is the difference between the first relative luminance value and the second relative luminance value, a weighted difference that is the difference between the first luminance value times a first factor and the second luminance value times a second factor, or a combined luminance value obtained using DWC. Even when an image contains a bright region unrelated to a retroreflecting material, most of a region where the luminance value does not change much regardless of the presence/absence of light emission for photography is removed by acquiring a differential image.

It is to be noted that, even if a differential image is acquired, a bright region unrelated to a reflected light from a retroreflecting material may still be included as illustrated in FIG. 2C. Accordingly, the differential processor 142 sets a proper threshold for luminance values and performs binarization on the obtained differential image to generate a binarized image as illustrated in FIG. 2D. In some cases, for each pixel of the differential image, the differential processor 142 determines the binarized value in such a way that the luminance value is white when the luminance value is equal to or greater than the threshold, and black when the luminance value is less than the threshold. Alternatively, the threshold can be applied directly to the image captured using light emission for photography as described in the flowchart of FIG. 10.

Then, as described below, the differential processor 142 extracts a region where light reflected at the retroreflecting material is recorded based on the area of the region where a difference is present and the size of the area using a differential image before binarization and a binarized image after binarization. Other region properties may also be used to extract the retroreflecting region. The other region properties include, for example, perimeter of the contour of the retroreflecting region, number of pixels included in the contour, aspect ratio (width/height of bounding rectangle), area of minimum bounding rectangle, extent (ratio of contour area to minimum bounding rectangle area), feret ratio (maximum feret diameter/breadth of contour), circularity (4π*contour area/contour perimeter²), convex hull (region points of enclosing convex hull), convex hull area, solidity (ratio of contour area to its convex hull area), the diameter of the circle whose area is equal to the region area, the median stroke width of the stroke width transform, and the variance of stroke width values produced using the stroke width transform, and the like.

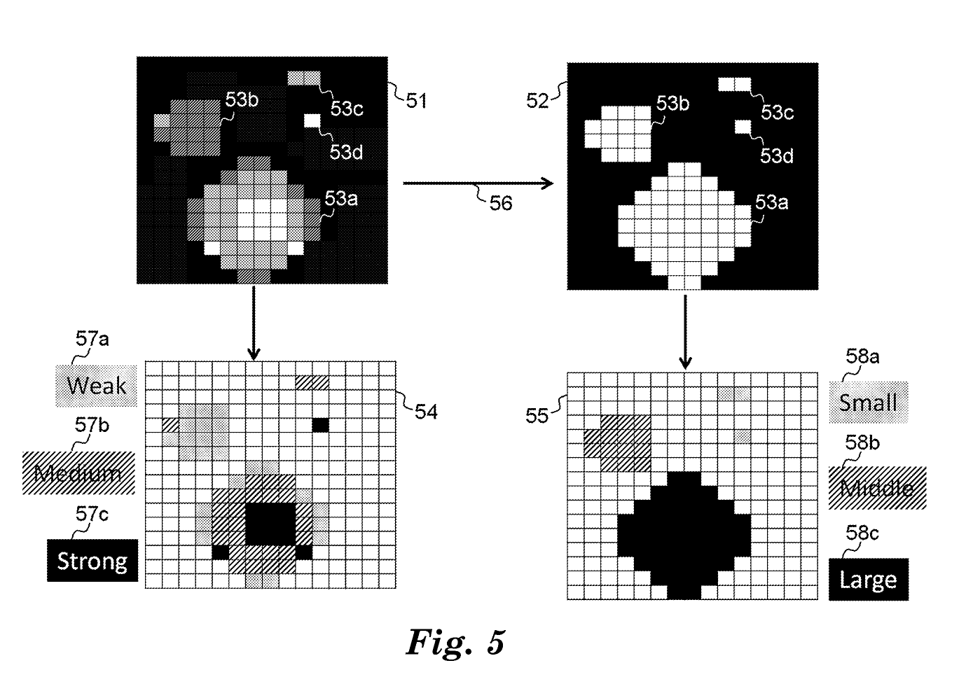

FIG. 5 is a diagram illustrating an example of a method of extracting a target region on an image. Suppose that a binarized image 52 has been acquired by performing binarization 56 on a differential image 51. In the example of FIG. 5, four large and small regions 53a to 53d are seen as regions containing differences.

The differential processor 142 separates the luminance values of the differential image 51, for example, into three levels of Weak 57a, Medium 57b, and Strong 57c to generate a differential image 54. Then, the differential processor 142 extracts any region containing a pixel with a luminance value of “Strong” from the regions 53a to 53d containing differences. In the example of FIG. 5, the regions 53a and 53d are extracted from the differential image 54. In addition, the differential processor 142 separates the area of the binarized image 52, for example, in three levels of Small 58a, Middle 58b, and Large 58c to generate a binarized image 55. Then, the differential processor 142 extracts any region whose area is “Large” from the regions 53a to 53d containing differences. In the example of FIG. 5, the region 53a is extracted from the binarized image 55. Further, the differential processor 142 extracts any region which contains a pixel with a luminance value of “Strong” and whose area is “Large” as a region where light reflected at the retroreflecting material is recorded. In this manner, the region 53a is finally extracted in the example of FIG. 5.

Further, when the shape of an image region to be detected which is applied with the retroreflecting material is known, the differential processor 142 can remove a region whose shape is far from the known shape as noise. To achieve this removal, the shape of the image region to be detected may be stored in advance in the storage unit 13, and the differential processor 142 may determine whether the extracted image region is the image region to be detected through pattern recognition. For example, the differential processor 142 may calculate the value of the circularity or the like of the extracted region when the image region to be detected is known to be circular, or may calculate the value of the aspect ratio or the like of the extracted region when the image region to be detected is known to be rectangular, and compare the calculated value with the threshold to select a region.

The differential processor 142 may extract a target region from a differential image using another image recognition technique, or may extract a target region according to the user's operation of selecting a region through the operation unit 15.

Further, the differential processor 142 generates an output image visually representing a region where a difference is present based on the obtained differential image. For example, the differential processor 142 generates noise-removed binarized image as a final output image as illustrated in FIG. 2E. Alternatively, the differential processor 142 may generate an output image in such a form that a symbol or the like indicating a retroreflecting region is placed over a level (contour line) map, a heat map, or the like indicating the level of the luminance value for each pixel. To permit easy discrimination of an image region where light reflected at the retroreflecting material is recorded, the differential processor 142 may generate an output image in which, for example, an outer frame emphasizing the image region or an arrow pointing out the image region is displayed over the original image or the differential image. The generated output image is displayed on the display unit 16.

The calculating unit 143 calculates the feature indicator of the retroreflecting region extracted by the differential processor 142. The feature indicator is, for example, the area or the luminance value of the retroreflecting region. As the luminance value, the calculating unit 143 calculates, for example, the average value of relative luminance values or absolute luminance values obtained for the pixels of the target region by conversion performed by the converter 141. Alternatively, the feature indicator may be a quantity, such as circularity, that relates to the shape of the retroreflecting region, or can be one or more of other properties, for example, or can be one or more of many properties: area and perimeter of the contour, number of pixels included in the contour, aspect ratio (width/height of bounding rectangle), area of minimum bounding rectangle, extent (ratio of contour area to minimum bounding rectangle area), feret ratio (maximum feret diameter/breadth of contour), circularity (4π*contour area/contour perimeter²), convex hull (contour points of enclosing convex hull), convex hull area, solidity (ratio of contour area to its convex hull area), the diameter of the circle whose area is equal to the contour area, the median stroke width of the stroke width transform, and the variance of stroke width values produced using the stroke width transform, or the like. The calculating unit 143 causes the display unit 16 to display the calculated feature indicator along with the output image generated by the differential processor 142. This permits the user to easily determine whether the detected image region is the target region or unnecessary noise.

The determination unit 144 determines whether the feature indicator calculated by the calculating unit 143 lies within a predetermined reference range. For example, the determination unit 144 determines whether the area or the luminance value of the retroreflecting region is equal to or larger than a predetermined threshold. For an image of a signboard or the like to which a retroreflecting material is applied, the determination unit 144 determines that the retroreflecting material is not deteriorated when the area or the luminance value is equal to or larger than the threshold, and determines that the retroreflecting material is deteriorated when the area or the luminance value is less than the threshold.

For an image of a surface or the like from which a retroreflecting material has been removed by cleaning, the determination unit 144 determines that the retroreflecting material has been removed when the area or the luminance value is less than the threshold, and determines that the retroreflecting material has not been removed when the area or the luminance value is equal to or larger than the threshold. The determination unit 144 may instruct the display unit 16 to display the determination result along with the output image generated by the differential processor 142. This permits the user to determine whether or not the status of the target retroreflecting material satisfies the demanded level.

Alternatively, the determination unit 144 may determine to which one of a plurality of predetermined segments the area or the luminance value calculated by the calculating unit 143 belongs. For example, the determination unit 144 may determine to which one of the three levels of Small, Middle, and Large the area belongs, or to which one of the three levels of Weak, Medium, and Strong the luminance value belongs, and may cause the display unit 16 to display the determination result.

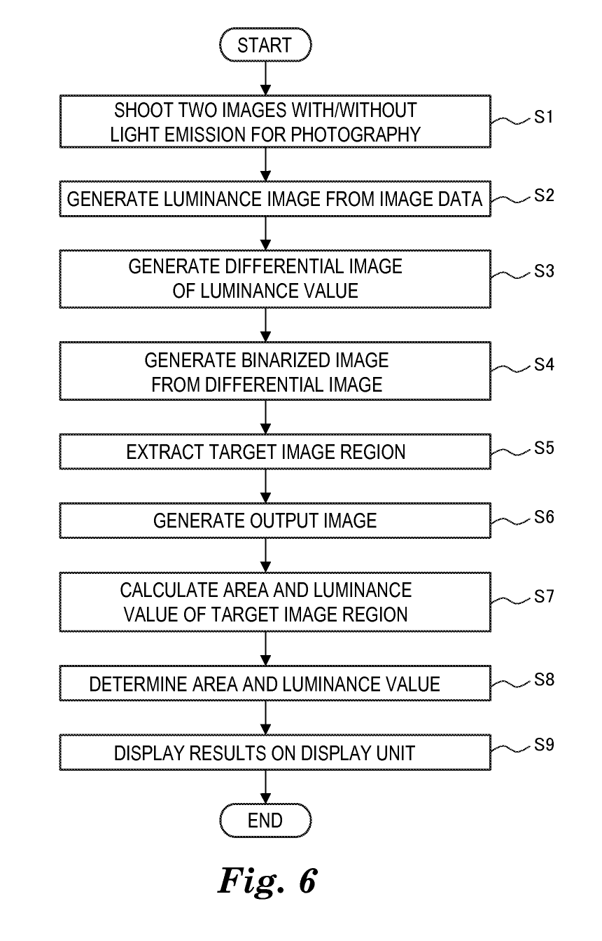

FIG. 6 is a flowchart illustrating an example of the process of detecting an image region where light reflected by a retroreflecting material is recorded. The control unit 14 performs the processes of the individual steps in FIG. 6 in cooperation with the individual components of the terminal device 1 based on a program stored in the storage unit 13.

First, the control unit 14 causes the imaging unit 11 and the light emitting unit 12 to shoot a first image using light emission for photography, and, at substantially the same time, causes the imaging unit 11 and the light emitting unit 12 to shoot a second image without using light emission for photography (step S1).

Next, the converter 141 of the control unit 14 acquires the first image data and the second image data shot in step S1, and converts the individual pieces of image data to linear scale luminance values to generate two luminance images (step S2). The luminance values may be relative luminance values obtained by the first converter 141A, or absolute luminance values obtained by the second converter 141C.

Next, the differential processor 142 of the control unit 14 obtains the difference between the luminance values of the first image data and the second image data obtained in step S2 for each pixel to generate a differential image (step S3). Further, the differential processor 142 performs binarization on the differential image to generate a binarized image (step S4), and extracts a region where light reflected from the retroreflecting material is recorded based on the area and luminance value of a region in the differential image where a difference is present (step S5). Then, the differential processor 142 generates an output image indicating the extracted image region (step S6).

Further, the calculating unit 143 of the control unit 14 calculates, for example, the area and luminance value as characteristic quantities of an image region extracted in step S5 (step S7). Noise is canceled based on the shape or the like if needed. Then, the determination unit 144 of the control unit 14 determines whether or not the area and the luminance value calculated in step S7 lie in predetermined reference ranges (step S8). Finally, the control unit 14 causes the display unit 16 to display the output image generated in step S6, the area and the luminance value calculated in step S7, and the determination result in step S8 (step S9). As a consequence, the detection process in FIG. 6 is terminated.

As described above, the terminal device 1 generates a differential image relating to the luminance values from the first image data acquired using the light emission for photography and the second output image acquired without using the light emission for photography, and uses the differential image to detect a region where light reflected at the retroreflecting material is recorded. The retroreflected light can easily be detected when the shooting direction substantially matches the direction from which illumination light emitted from a point light source, a beam light source or the like is incident to the retroreflecting material and reflected therefrom. However, when the captured image contains a high-luminance portion such as a white object, detection of such retroreflected light may become difficult. Even in such a case, the differential processor 142 in the terminal device 1 performs image processing mainly using a luminance difference to remove such a high-luminance and unnecessary portion, thereby making possible automatic detection of a region where light reflected at the retroreflecting material is recorded. The terminal device 1 can be achieved by a hand-held device incorporating all the necessary hardware by merely installing the program for achieving the functions of the control unit 14 in the hand-held device.

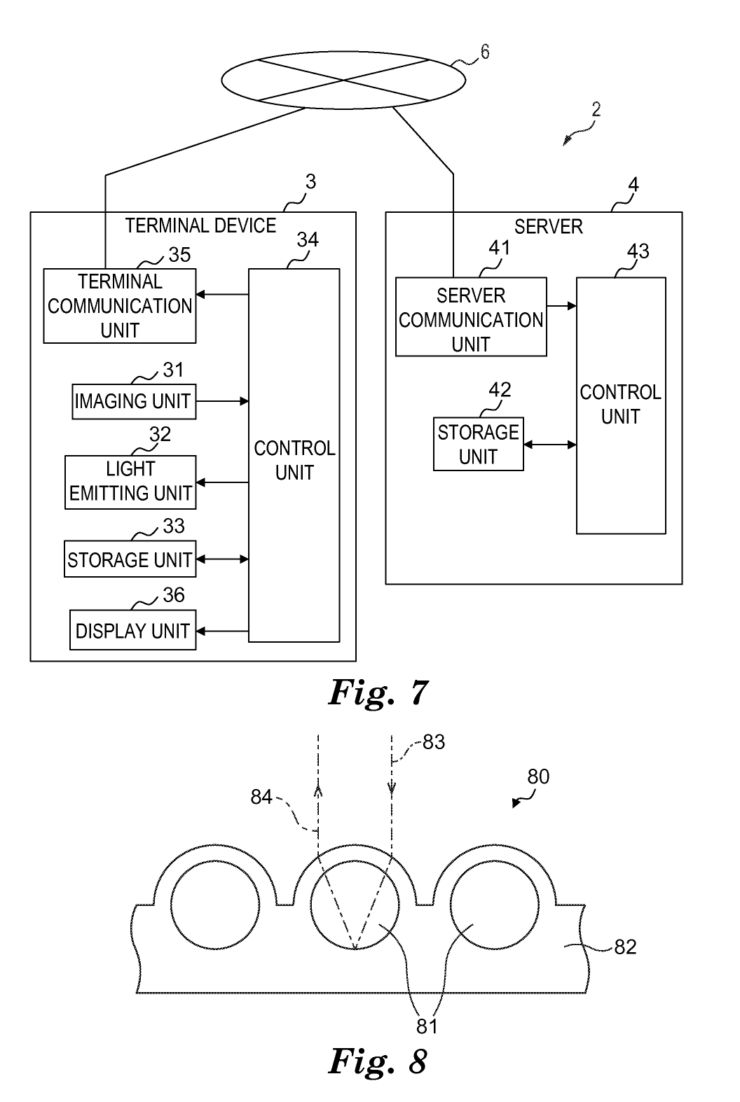

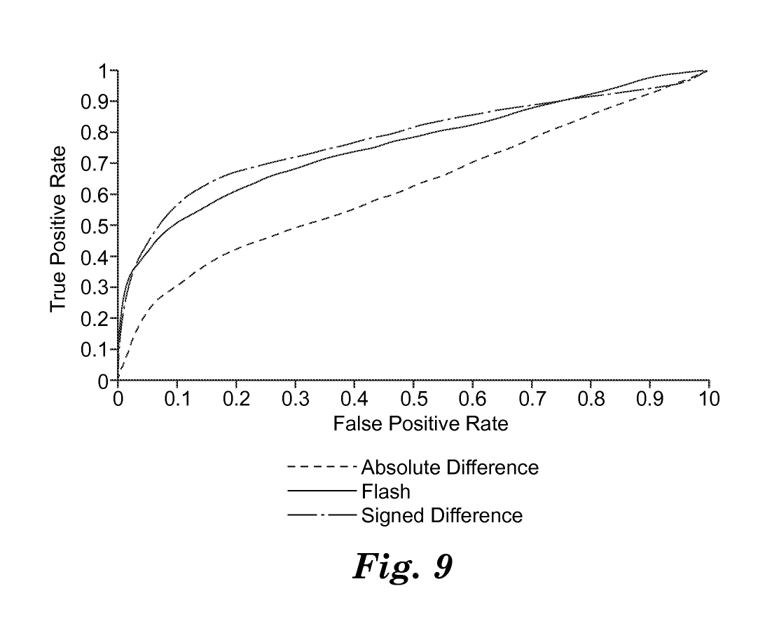

FIG. 7 is a schematic configuration diagram of the communication system 2. The communication system 2 includes a terminal device 3 and a server 4 which are able to communicate with each other. Those two components are connected to each other over a wired or wireless communication network 6.

The terminal device 3 includes an imaging unit 31, a light emitting unit 32, a storage unit 33, a control unit 34, a terminal communication unit 35, and a display unit 36. The imaging unit 31 shoots the image of an object for measurement to acquire image data of the object for measurement in the form of RAW (DNG) data, JPEG (JFIF) data, sRGB data, or the like. The light emitting unit 32 is disposed adjacent to the imaging unit 31, and emits light as needed when the imaging unit 11 shoots an image. The storage unit 33 stores data acquired by the imaging unit 31, data necessary for the operation of the terminal device 3, and the like. The control unit 34 includes a CPU, RAM, and ROM, and controls the operation of the terminal device 3. The terminal communication unit 35 transmits first image data acquired by the imaging unit using light emission for photography and second output image acquired by the imaging unit without using the light emission for photography to the server 4, and receives an output image generated based on the first image data and the second image data, and determination information that comes with the output image from the server 4. The display unit 36 displays the output image received from the server 4, determination information that comes with the output image, and the like.

The server 4 includes a server communication unit 41, a storage unit 42, and a control unit 43. The server communication unit 41 receives the first image data and the second image data from the terminal device 3, and transmits an output image to the terminal device 3. The storage unit 42 stores image data, shooting information, data needed for the operation of the server 4, and the like received from the terminal device 3. The control unit 43 includes a CPU, RAM, and ROM, and has functions similar to those of the control unit 14 of terminal device 1. That is, the control unit 43 converts the first image data and second image data to luminance values, calculates the difference between a first luminance value based on the first image data and a second luminance value based on the second image data for each pixel, and generates an output image visually representing a region where there is a difference based on obtained differential image, determination information that comes with the output image, and the like.

In the aforementioned manner, the image shooting and displaying processes, and the process of converting image data and generating an output image and determination information that comes with the output image and the like may be carried out by separate devices. The communication system 2 may further include a separate display device different from the display unit of the terminal device 3 to display an output image.

A computer program for permitting a computer to achieve the individual functions of the converter may be provided in the form of being stored in a computer readable storage medium such as a magnetic recording medium or an optical recording medium.

### Exemplary Embodiments

Item 1. An apparatus comprising: an imaging unit;

a converter that converts, into luminance values, first image data captured by the imaging unit using light emission for photography and second image data captured by the imaging unit without using the light emission for photography;

a differential processor that calculates a difference between a first luminance value based on the first image data and a second luminance value based on the second image data for each pixel to generate an output image visually representing a region where the difference is present based on an obtained differential image; and

a display unit that displays the output image.

Item 2. The apparatus according to Item 1, wherein the differential processor detects a region where light is reflected by a retroreflecting material in the first image data or the second image data based on an area of a region on the differential image having the difference, a shape of the region, or a size of the difference.

Item 3. The apparatus according to Item 2, further comprising a calculating unit that calculates a feature indicator of a region on the differential image where light reflected by the retroreflecting material is observed.

Item 4. The apparatus according to Item 3, wherein the display unit displays the feature indicator calculated by the calculating unit along with the output image.

Item 5. The apparatus according to Item 3 or 4, further comprising a determination unit that determines whether or not the feature indicator calculated by the calculating unit lies within a predetermined reference range, wherein the display unit displays a result of determination made by the determination unit along with the output image.

Item 6. The apparatus according to any one of Items 1 to 5, wherein the converter converts each of the first image data and the second image data to data including a relative luminance value, and the differential processor calculates a difference between a first relative luminance value based on the first image data and a second relative luminance value based on the second image data for each pixel and generates the differential image.

Item 7. The apparatus according to any one of Items 1 to 5, wherein the converter converts each of the first image data and the second image data to data including a relative luminance value, and

acquires a reference luminance value of a subject using image information from the imaging unit for each of the first image data and the second image data, and converts the relative luminance value for each pixel into an absolute luminance value, using the reference luminance value; and

the differential processor calculates a difference between a first absolute luminance value based on the first image data and a second absolute luminance value based on the second image data for each pixel and generates the differential image.

Item 8. The apparatus according to any one of Items 1 to 7, further comprising a light emitting unit disposed adjacent to a lens forming the imaging unit.

Item 9. A system including a terminal device and a server that are able to communicate with each other,

the terminal device comprising

an imaging unit;

a terminal communication unit that transmits first image data captured by the imaging unit using light emission for photography and second image data captured by the imaging unit without using the light emission for photography to the server, and receives, from the server, an output image produced based on the first image data and the second image data, and

a display unit that displays the output image,

the server comprising:

a converter that converts the first image data and the second image data to luminance values,

a differential processor that calculates a difference between a first luminance value based on the first image data and a second luminance value based on the second image data for each pixel and generates an output image visually representing a region where the difference is present based on an obtained differential image, and

a server communication unit that receives the first image data and the second image data from the terminal device, and transmits the output image to the terminal device.

Item 10. A program that is realized on a computer, comprising:

acquiring first image data picked up by an imaging apparatus using light emission for photography and second image data picked up by the imaging apparatus without using light emission for photography;

converting the first image data and the second image data to luminance values;

calculating a difference between a first luminance value based on the first image data and a second luminance value based on the second image data for each pixel to generate a differential image; and

generating display data for displaying an output image visually representing a region where the difference is present based on the differential image.

Item 11. An apparatus comprising:

an imaging unit;

a converter configured to convert into first luminance values for first image data captured by the imaging unit using light emission for photography; and

a differential processor configured to apply a pattern recognition algorithm to first luminance values to calculate processed values and generate an output image in the processed values, wherein the differential processor identifies a retroreflecting region in the output image where light is reflected by a retroreflecting material using the processed values.

Item 12. The apparatus according to Item 11, wherein the pattern recognition algorithm comprises at least one of a binarization algorithm, a decision tree.

Item 13. The apparatus according to Item 11 or 12, wherein the converter is further configured to convert into second luminance values for second image data captured by the imaging unit without using light emission for photography, and wherein the differential processor is further configured to apply a differential algorithm to the first luminance values and the second luminance values to generate differential values, wherein the differential processor is further configured to identify the retroreflecting region in the output image using the differential values.

Item 14. The apparatus according to any one of Item 11-13, wherein the differential processor identifies the retroreflecting region based on at least one of the area of the retroreflecting region, the shape of the retroreflecting region, the processed values for pixels within the retroreflecting region, extent of the retroreflecting region, feret ratio of the retroreflecting region, and circularity of the retroreflecting region.

Item 15. The apparatus according to any one of Item 11-14, wherein the differential processor further applies a filter to the processed values to generate the output image.

Item 16. The apparatus according to any one of Item 11-15, further comprising: a display unit that displays the output image.

Item 17. The apparatus according to any one of Item 11-16, further comprising a calculating unit that calculates a feature indicator of the retroreflecting region in the output image.

Item 18. The apparatus according to Item 17, wherein the feature indicator comprises at least one of area of the retroreflecting region, luminance value of the retroreflecting region, and a shape parameter of the retroreflecting region.

Item 19. The apparatus according to Item 17, further comprising: a display unit that displays the feature indicator calculated by the calculating unit.

Item 20. The apparatus according to Item 17, further comprising: a determination unit that determines whether or not the feature indicator calculated by the calculating unit lies within a predetermined reference range.

Item 21. The apparatus according to any one of Item 11-20, further comprising: a light emitting unit configured to emit light disposed proximate to the imaging unit.

The present invention should not be considered limited to the particular examples and embodiments described above, as such embodiments are described in detail to facilitate explanation of various aspects of the invention. Rather the present invention should be understood to cover all aspects of the invention, including various modifications, equivalent processes, and alternative devices falling within the spirit and scope of the invention as defined by the appended claims and their equivalents.

What is claimed is:

1. An apparatus comprising:
an imaging unit;
a converter that converts, into luminance values, first image data captured by the imaging unit using light emission for photography and second image data captured by the imaging unit without using the light emission for photography; and
a differential processor that calculates a differential value using a first luminance value based on the first image data and a second luminance value based on the second image data for each pixel and generates an output image using the differential value.

2. The apparatus according to claim 1, wherein the differential processor identifies a region in the output image where light is reflected by a retroreflecting material in the first image data or the second image data based on the differential values.

3. The apparatus according to claim 2, wherein the differential processor identifies the region based on at least one of factors of the area of the region, the shape of the region, and differential values within the region.

4. The apparatus according to claim 1, wherein the differential processor further applies a filter to the differential value of each pixel to generate the output image.

5. The apparatus according to claim 4, wherein the filter comprises at least one of a binarization algorithm, a pattern recognition algorithm, a discriminant classifier, support vector machine, random forests.

6. The apparatus according to claim 1, further comprising: a display unit that displays the output image.

7. The apparatus according to claim 2, further comprising a calculating unit that calculates a feature indicator of the region in the output image where light reflected by the retroreflecting material is observed.

8. An apparatus comprising:
an imaging unit;
a converter configured to convert into first luminance values for first image data captured by the imaging unit using light emission for photography; and
a differential processor configured to apply a pattern recognition algorithm to first luminance values to calculate processed values and generate an output image in the processed values, wherein the differential processor identifies a retroreflecting region in the output image where light is reflected by a retroreflecting material using the processed values.

9. The apparatus according to claim 8, wherein the pattern recognition algorithm comprises at least one of a binarization algorithm, a decision tree, a discriminant classifier, support vector machine, and a random forest.

10. The apparatus according to claim 8, wherein the converter is further configured to convert into second luminance values for second image data captured by the imaging unit without using light emission for photography, and wherein the differential processor is further configured to apply a differential algorithm to the first luminance values and the second luminance values to generate differential values, wherein the differential processor is further configured to identify the retroreflecting region in the output image using the differential values.

11. The apparatus according to claim 8, wherein the differential processor identifies the retroreflecting region based on at least one of the area of the retroreflecting region, the shape of the retroreflecting region, the processed values for pixels within the retroreflecting region, extent of the retroreflecting region, feret ratio of the retroreflecting region, and circularity of the retroreflecting region.

12. The apparatus according to claim 8, wherein the differential processor further applies a filter to the processed values to generate the output image.

13. The apparatus according to claim 8, further comprising a calculating unit that calculates a feature indicator of the retroreflecting region in the output image.

14. The apparatus according to claim 13, wherein the feature indicator comprises at least one of area of the retroreflecting region, luminance value of the retroreflecting region, and a shape parameter of the retroreflecting region.

15. The apparatus according to claim 13, further comprising:
a determination unit that determines whether or not the feature indicator calculated by the calculating unit lies within a predetermined reference range.
